(19) United States
(12) Patent Application Publication
(10) Pub. No.: US 2004/0042580 A1
(43) Pub. Date: Mar. 4, 2004

(54) Fuel assembly and a tubular element for a nuclear boiling water reactor

(76) Inventor: Olov Nylund, Vasteras (SE)

Correspondence Address: Swidler Berlin Shereff Friedman, 3000 K Street, Suite 300, Washington, DC, 20007, US

(21) Appl. No.: 10/415,814

(22) PCT Filed: Oct. 31, 2001
(86) PCT No.: PCT/SE01/02386

(30) Foreign Application Priority Data
Nov. 2, 2000 (SE) 0004013-9

(51) Int. Cl. G21C 3/00

(52) U.S. Cl. 376/433

(57) ABSTRACT

The present invention relates to a fuel assembly (10) and a tubular element (32, 32′) for a nuclear boiling water reactor. The fuel assembly (10) comprises a plurality of full-length fuel rods (14), at least one part-length fuel rod (15) and at least a tubular element (32, 32′), which is arranged above the part-length fuel rod (15) in the fuel assembly (10). A cooling medium flows, during the operation of the boiling water reactor, upwardly through the fuel assembly (10) in order to cool the fuel rods (14, 15). A part of the cooling medium flow is guided into the tubular element (32, 32′) through at least one inlet opening (34, 34′) and out through at least one outlet opening (36). The tubular element (32, 32′) comprises in the vicinity of the outlet opening (36) an internally arranged body (44, 46) having a surface (38), which deflects at least a main part of the upwardly directed cooling medium flow in the tubular element (32, 32′) out through the outlet opening (36) and in a direction towards a full-length fuel rod (14).

### BACKGROUND OF THE INVENTION AND PRIOR ART

The present invention relates to a fuel assembly and a tubular element for en nuclear boiling water reactor, wherein the fuel assembly comprises a plurality of full-length fuel rods, which extend from substantially a first level located in a lower part of the fuel assembly to substantially a second level located in an upper part of the fuel assembly, at least one part-length fuel rod, which extends substantially from said first level and upwardly but not right up to the second level, and at least a tubular element, which is arranged in an area located above the position of the part-length fuel rod in the fuel assembly, wherein a cooling medium is arranged to flow upwardly through the fuel assembly, during operation of boiling water reactor, in order to cool the fuel rods and that at least a part of the cooling medium flow which passes through said area is arranged to be guided into the tubular element through at least one inlet opening and out through at least one outlet opening.

In a fuel assembly for a nuclear boiling water reactor, there is a number of fuel rods, which contain a nuclear fuel material. When the fuel assembly is in operation in a nuclear plant, a cooling medium, usually water, flows through the fuel assembly. This water has several functions. The water functions partly as cooling medium for cooling the fuel rods such that they do not become overheated. The water works partly as neutron moderator, i.e. the water retards the neutrons to a lower velocity. Thereby, the reactivity of the reactor increases. Usually, the water flows through the fuel assembly from the bottom and upwardly. Therefore, the water has been heated to a higher extent in the upper part of the fuel assembly. That results in the content of steam being larger in the upper part of the fuel assembly than in the lower part. Usually, the vaporised water is used to drive a turbine. Since the steam has a relatively low density, the steam at the upper part of the fuel assembly is a poorer moderator than the water in the lower part of the fuel assembly.

In order to obtain a high efficiency and a high security there are many different demands on a nuclear reactor. One demand is that the reactivity is not too high when the reactor is shut down. Another object is that the reactivity is as high as possible when the reactor is in operation. A further demand is that the cooling of the fuel rods is sufficient such that a so-called dry out does not arise. Dry out implies that the water film, which is present on the surface of the fuel rods, disappears or is broken down. This results in a locally deteriorated heat transfer between the fuel rod and the water flowing through the fuel assembly. This results in its turn to an increased wall temperature of the fuel rods. The increased wall temperature may result in serious damages on the fuel rod. A further demand is that the pressure drop is not too high in the fuel assembly, i.e. that a too large difference does not prevail between the pressure of the cooling medium at the lower part of the fuel assembly in comparison with the upper part of the fuel assembly. Such a pressure drop results namely in losses of effect.

In order to fulfil the different demands of security, to attain a sufficient cooling of the fuel rods and, at the same time, to obtain a high reactivity in operation, a great number of different technical solutions have been proposed. It is, for example, common that a fuel assembly has one or several water channels through which a non-boiling water flows upwardly through the fuel assembly. Thereby, the quantity of non-boiling water in the fuel assembly is increased. That results in that a good moderation is attained.

Furthermore, it exists different proposals regarding the use of fuel rods having different length. I.e. a number of shorter fuel rods are arranged in the fuel assembly in such a way that these fuel rods do not reach the same height in the fuel assembly as the other longer fuel rods. Thereby, the content of water at the upper part of the fuel assembly is increased at the same time, as the quantity of nuclear fuel material is lower at the upper part.

EP-B1-0 514 117 describes different embodiments of fuel assemblies having so-called part-length fuel rods. Above such part-length fuel rods, a space is created where a mixture of liquid water and water steam flows upwardly through the fuel assembly. This document discusses principally the problem that the water may be forced into the steam, which flows upwardly in said space. In order to solve this problem it is proposed in this document that different kinds of flow influencing elements are placed in the space. These elements may either extend from and be connected to the part-length fuel rods or also be arranged in another way above these part-length fuel rods. The document also mentions the possibility that such flow influencing elements are kept at place in the fuel assembly by means of spacers. It is common for the flow influencing elements described in this document, that the water is influenced to leave said space in all different directions beside of said space. I.e. the cooling medium flow is not deflected in any particular determined direction. Furthermore, it has been proved that this kind of flow influencing element described in said document results in a relatively great pressure drop in the fuel assembly.

U.S. Pat. No. 5,859,888 describes an extension tube, which is arranged to be provided above a part-length fuel rod in a fuel assembly. The extension tube comprises a large number of holes distributed along its circumferential surface and an internally arranged helical flow path. A mixture of liquid and steam is sucked into the extension tube through the holes arranged at a lower portion of the extension tube. During the flow of the liquid and steam mixture upwardly inside the extension tube, the internal helical path is passed. The liquid and steam mixture obtains here a vortex motion and the heavier liquid droplets are separated radially outwards from the steam. The liquid droplets are guided radially outwards through the holes in the extension tube and towards adjacent full-length fuel rods. Nor in this case, liquid droplets are guided in any particular direction but they hit substantially randomly the adjacently located full-length fuel rods.

### SUMMARY OF THE INVENTION

The object of the present invention is to provide a fuel assembly of the initially mentioned kind, which guaranties an improved cooling of the full-length fuel rods. A further object is to accomplish such a good cooling of the fuel rods without causing a greater pressure drop in the fuel assembly. A further object is to attain these advantages in a relatively simple and inexpensive way. A further object of the invention is to provide a tubular element adapted to be arranged in a fuel assembly, which tubular element allows the attainment of said objects of the invention.

The above-mentioned objects are achieved by the fuel assembly of the initially mentioned kind, which is characterised in that the tubular element comprises, in the vicinity of the outlet opening, an internally arranged body having a surface, which is arranged to deflect at least a main part of the upwardly flowing cooling medium in the tubular element out through the outlet opening and in a direction towards a full-length fuel rod. Since the tubular element is shaped to deflect at least the main part of the cooling medium flow in a determined direction towards a full-length fuel rod, a well-controlled flow direction of the cooling medium towards a full-length fuel rod is attained. If the tubular element comprises several outlet openings, they may guide the cooling medium flow towards different full-length fuel rods. Advantageously, the cooling medium flow directed towards the full-length fuel rods comprises a relatively high content of liquid. Thereby, the risk for dry out of the upper portion of the full-length fuel rods decreases and the cooling is improved. It is also relatively simple to arrange the tubular element in the fuel assembly since there is a free space in the area above a part-length fuel rod.

According to a preferred embodiment of the present invention, said surface comprises an inclined path which has an extension from a lower edge portion to an upper edge portion in a direction towards the outlet opening. The upwardly flowing medium obtains a radial deflection towards the outlet opening when it hits said surface. Since the surface inclines upwardly towards the outlet opening a relatively gentle deflection of the cooling medium flow towards the outlet opening is obtained. Advantageously, said inclined path comprises, in the direction towards the outlet opening, an increased inclination in relation to the upwardly directed cooling medium flow in the tubular element. Thereby, the cooling medium flow obtains a successive transverse deflection towards the outlet opening, which results in low losses of flow and a substantially negligible reduction of the velocity.

According to another preferred embodiment of the present invention, the upper edge portion is connected to a wall portion of the tubular element, which wall portion defines an upper edge of the outlet opening. Hereby, an inclined path is obtained, which guides the cooling medium flow from the lower edge portion the whole way up to the outlet opening. Advantageously, the lower edge portion is connected to a wall portion located at an opposite side of the outlet opening in the tubular element. Hereby, a continuous inclined path across the whole width of the tubular element is obtained. The main part of the cooling medium, which flows upwardly in the tubular element, is thereby deflected out through the outlet opening. Such a body may comprise a partly cut-out first material portion, which has been bent inwardly into the tubular element such that the original inner surface of the cut-out first material portion forms said surface and that the cut-out area in the wall of the tubular element forms an inlet opening. Such a body of a cut-out material portion may be obtained in a relatively simple way and, thus, it does not require any supply of a supplementing material. At the same time, an inlet opening for the cooling medium is obtained in the cut-out material surface. Advantageously, the original upper edge portion of the first material portion is connected, by a fastening means, to said wall portion, which defines an upper edge of the outlet opening. Hereby, the surface, deflecting the cooling medium flow, obtains an extension across the inner wall surfaces of the tubular element. The body obtains, by said fastening means, also a stable attachment such that a relatively heavy cooling medium flow may be resisted welding is here a suitable fastening method.

According to another preferred embodiment of the present invention, said surface extends across the whole inner cross sectional area of the tubular element. Thereby, the whole upwardly flowing cooling medium flow in the tubular element obtains a deflection laterally towards an adjacent full-length fuel rod. Advantageously, said body comprises a plug, which comprises said surface at a lower portion. It is relatively uncomplicated to shape a plug to have a suitable surface for deflecting the cooling medium flow. Advantageously, said plug is also arranged to allow a joining of the tubular element with the part-length fuel rod and/or other tubular elements. Consequently, such a plug provides two functions of the tubular element.

According to another preferred embodiment of the present invention, said inlet openings comprise a plurality of partly cut-out and inwardly bent material portions in the wall surface of the tubular element. Advantageously, such relatively small openings are arranged in a relatively great number around the circumference of the tubular element at a plurality of height levels. By such inwardly bent material portions, the existing water film on the surface of the tubular element is guided into the tubular element. Such openings may exclusively or in combination with a few numbers of larger openings constitute the inlet openings of the cooling medium in the tubular element.

According to a preferred embodiment of the fuel assembly, the tubular element is arranged in a position close to the casing wall. Advantageously, the inlet openings are directed towards the casing wall of the fuel assembly such that the cooling medium, which flows upwardly between the casing wall and the tubular element, at least partly is guided in through the inlet openings. Usually, this cooling medium contains a higher content of liquid than the cooling medium flowing more centrally through the fuel assembly. Therefore, it is suitable to guide this cooling medium inwardly towards the centrally placed full-length fuel rods in order to cool these. Alternatively, the tubular element is arranged in a position close to a central cooling medium channel in the fuel assembly. Also in this area, the cooling medium usually contains a higher content of liquid than the cooling medium, which flows through the rest of the fuel assembly. Therefore, it is suitable to guide this cooling-medium also towards adjacent full-length fuel rods in order to cool these.

### BRIEF DESCRIPTION OF THE DRAWINGS

In the following, preferred embodiments of the invention are described as examples with reference to the attached drawings, in which:

FIG. 1 shows schematically a sectional view of a fuel assembly,

FIG. 2 shows schematically a sectional view of a tubular element according to en first embodiment,

FIG. 3a shows an outlet opening of the tubular element in FIG. 2,

FIG. 3b shows a sectional view of an inlet opening and an outlet opening of the tubular element in FIG. 2,

FIG. 3c shows an inlet opening of the tubular element in FIG. 2,

FIG. 4 shows a tubular element according to a second embodiment,

FIG. 5 shows a tubular element according to a third embodiment and

FIG. 6 shows a tubular element according to a forth embodiment.

### DETAILED DESCRIPTION OF EMBODIMENTS OF THE INVENTION

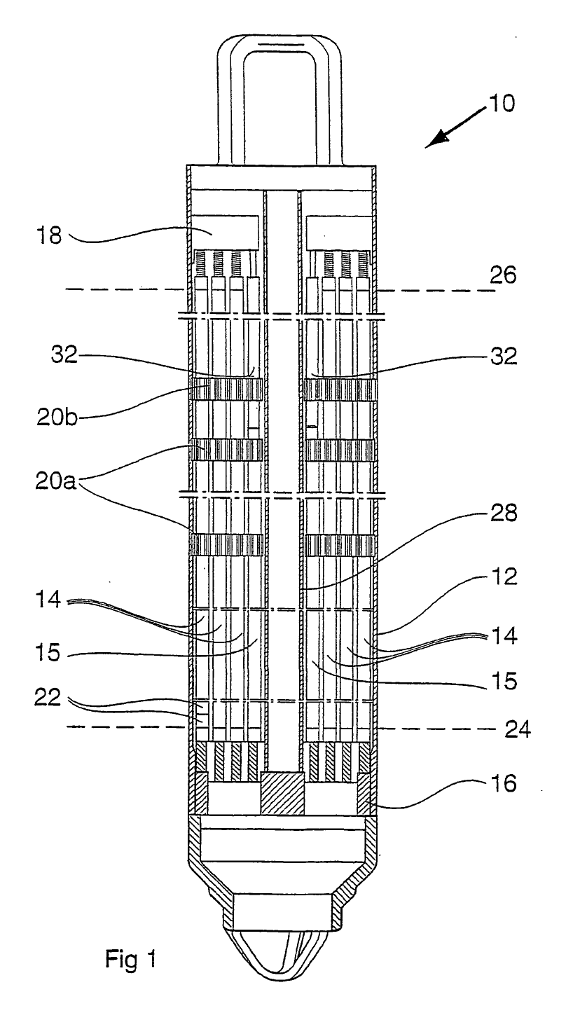

FIG. 1 shows a vertical section through a fuel assembly 10. The fuel assembly 10 comprises an external casing wall 12, which encloses a number of fuel rods 14, 15 arranged in the fuel assembly 10. Usually, the fuel rods 14, 15 are arranged in parallel with each other and have an extension in a vertical direction. However, it ought to be noted that the fuel rods 14, 15 do not necessarily have to be arranged vertically and in parallel with each other. There are fuel assemblies 10 with fuel rods 14, 15 having a certain inclination. The fuel rods 14, 15 comprise pellets 22 of nuclear fuel material, for example, in the form of uranium dioxide. The fuel rods 14, 15 are kept in place in bundles in the fuel assembly 10 by means of a bottom tie plate 16 and a top tie plate 18. In the fuel assembly, a number of spacers 20a, 20b are arranged. The spacers 20a, 20b have i.a. the function to hold the fuel rods 14, 15 at a determined distance from each other.

A part of the fuel rods 14, 15 constitutes full-length fuel rods 14, which extend from substantially a first level 24 located in a lower part of the fuel assembly 10 to substantially a second level 26 located in an upper part of the fuel assembly 10. The fuel assembly 10 comprises also at least one so-called part-length fuel rod 15. A part-length fuel rod 15 extends substantially from said first level 24 and upwardly but does not reach the same height in the fuel assembly 10 as the full-length fuel rods 14. Preferably, the fuel assembly 10 comprises a plurality of part-length fuel rods 15. Preferably, the part-length fuel rods 15 end, but not necessarily, in the area around a spacer 20a. In the showed embodiment, the part-length fuel rods 15 extend up to about the level where the upper one of the spacers marked with 20a is arranged. At least one spacer 20b is arranged at a level, which lies above the level which the part-length fuel rods 15 reach.

The fuel assembly 10 is designed to allow a cooling medium, which usually is water, to flow upwardly in the fuel assembly 10 between the fuel rods 14, 15. The water is heated by the fuel rods 14, 15 and the content of steam in the liquid increases successively. In the showed embodiment, the fuel assembly 10 also comprises a cooling medium channel 28 through which the liquid water is arranged to flow from below and upwardly. Advantageously, the part-length fuel rods 15 are arranged close to the casing wall 12 and/or said cooling medium channel 28. Usually, the fuel assembly comprises a plurality of spacers 20b arranged at different levels, which lie above the level which the part-length the fuel rods 15 reach. FIG. 1 shows, for the sake of clarity, only one such spacer 20b located at a higher level. It ought also to be noted that a spacer 20a, 20b does not need to extend across the whole cross section of the fuel assemblies 10. It is also possible to arrange a plurality of spacers side by side at the same level in the fuel assembly 10. For example, a well known kind of fuel assembly 10 comprises a water channel 28 and four further smaller water channels, which extend in a radial direction outwardly from a centrally arranged water channel 28. In such a kind of fuel assembly, the fuel rods 14, 15 are, for example, arranged in four part bundles. Advantageously, at each level of spacers 20a, 20b four spacers are then arranged side by side, one for each part bundle.

Above the part-length fuel rods 15, a space is created where the water both as gas and as liquid flows upwardly. The part of the water in the form of liquid, which flows upwardly in this space has a substantially vertical flow direction and thus it does not contribute appreciably in conventional fuel assemblies to the cooling of the surrounding full-length fuel rods 14. According to the present invention, tubular elements 32 have here therefore been arranged coaxially above the part-length fuel rods 15. The task of the tubular elements 32 is to deflect at least a part of the cooling medium flow in a determined direction towards one or several of the full-length fuel rods 14. Hereby, an increased cooling of the upper portions of the full-length fuel rods 14 is obtained at the same time as dry out of these is prevented.

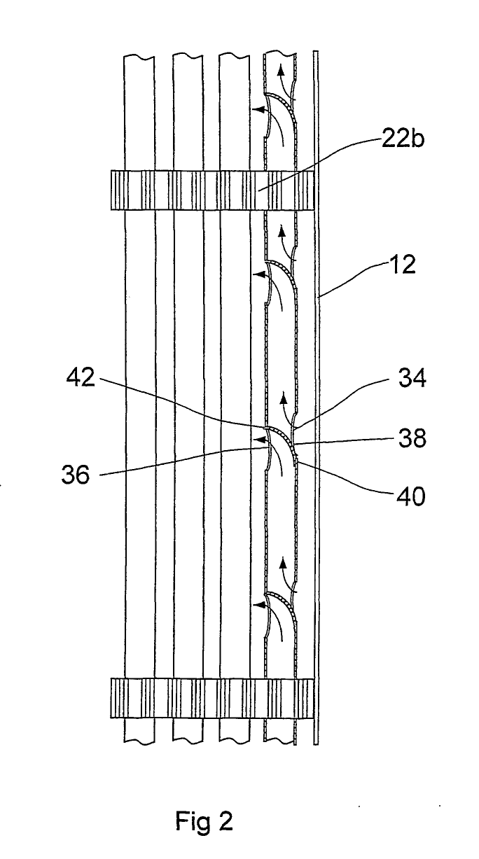

FIG. 2 shows a first embodiment of the tubular element 32. The tubular element 32 comprises here at the side, which is turned to the casing wall 12, a plurality of inlet openings 34 arranged at relatively constant intervals at different height levels in the fuel assembly 10. The tubular element 32 comprises at an opposite side, which is turned to a full-length fuel rod 14, a plurality of outlet openings 36 which also are arranged at relatively constant intervals at different height levels in the fuel assembly 10. At least a part of the cooling medium, which during operation of the boiling water reactor, flows upwardly in the fuel assembly 10 in the space between the casing wall 12 and the tubular element 32 is guided in through any of the inlet openings 34. The cooling medium is guided substantially vertically upwardly inside the tubular element 32 until the cooling medium hits a surface 38. The surface 38 comprises an inclined path having an extension from a lower edge portion 40 to an upper edge portion 42 in a direction towards the outlet opening 36. The inclined path comprises in the direction towards the outlet opening 36 an increased inclination in relation to the upwardly flowing cooling medium. The upwardly flowing cooling medium in the tubular element 32 is guided by the inclined surface 38 out through the outlet opening 36 in a direction towards the adjacent fuel rod 14. The inclined surface 38 is well curved and permits the losses of flow of the cooling medium at the deflection to be kept at a low level. Thereby, the cooling medium obtains a relatively small reduction of velocity when it is deflected towards the fuel rod 14. It is necessary that the transverse cooling medium flow has a relatively high initial velocity in order to be able to pass through the existing cooling medium flow, which flows upwardly between the tubular element 32 and the fuel rod 14, and to reach the adjacent fuel rod 14. The cooling medium which flows upwardly between the casing wall 12 and the tubular element 32 contains usually a higher content of liquid than the cooling medium which flows upwardly more centrally in the fuel assembly 10. Therefore, it is suitable to arrange the tubular element 32 close to a casing wall 12 in order to guide this cooling medium, which has a relatively high content of liquid, towards an upper portion of an adjacent full-length fuel rod 14.

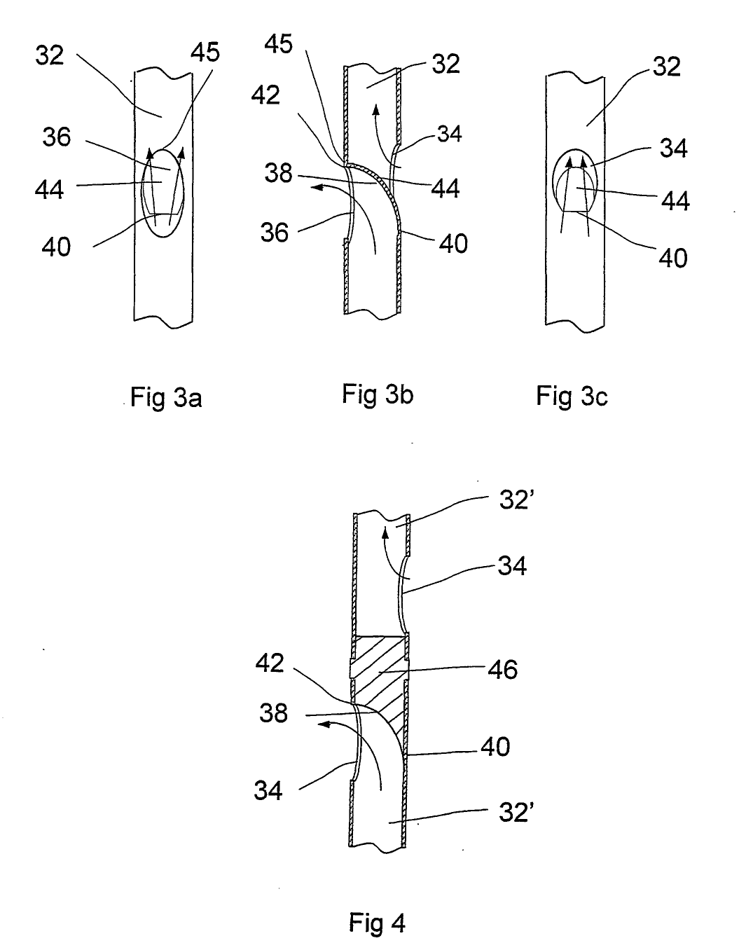

FIG. 3b shows more in detail a portion of the tubular element 32, in FIG. 2. This portion comprises an inlet opening 34 and an outlet opening 36. In order to manufacture such a tubular element 32, outlet openings 36 have initially been cut-out from a wall surface of the originally tubular element 32 at the side or the sides, which are arranged to be turned to the full-length fuel rods 14. Thereafter, inlet openings 34 have been created in that a first material portion 44 partly has been cut-out from the wall surface of the tubular element 32 at an opposite side. However, the first material portion 44 comprises a lower edge portion 40, which is connected to the tubular element 32. The first material portion 44 has thereafter been bent inwardly into the cavity of the tubular element 32 until an upper edge portion 42 of the first material portion 44 has reached the side of the tubular element 32, which comprises the outlet openings 36. The inlet openings 34 are here arranged at a small distance above the outlet openings 36 such that the upper edge portion 42 of the first material portion 44 is allowed to be welded to a wall portion 45 of the tubular element 32, which defines an upper edge of the outlet opening 36. The lower edge portion 40 defines in a corresponding way a lower edge of an inlet opening 34. The originally internal surface 38 of the first material portion 44 forms now a substantially inclined curved flow path between the lower edge portion 40 and the upper edge portion 42. By such a partly cut-out and inwardly bent first material portion 44, both an inlet opening 34 and a surface 38 having a suitable shape to deflect the cooling medium flow out through an outlet opening 36 and towards the adjacent full-length fuel rod 14 is obtained in a simple way. FIG. 3a shows an outlet opening 36 seen from the front. The outlet opening 36 has here a substantially oval shape but also other functional shapes are conceivable. FIG. 3c shows an inlet opening 34 seen from the front. The inlet opening 34 has also a substantially oval shape except at the lower edge portion 40, which has a substantially straight extension. Also, the shape of the inlet opening 34 may be varied.

FIG. 4 shows a tubular element 32, which consists of two co-axially connected tubular part elements 32′. A plug 46 is here inserted a distance in the respective coaxially connected ends of the tubular part elements 32′ such that the part elements 32′ are kept together. By using such intermediate plugs 46, a tubular element 32 may be constructed of a substantially arbitrary number of coaxially connected tubular part elements 32′. The showed upper tubular part element 32′ has at a lower portion been provided with an inlet opening 34 and the showed lower tubular part element 32′ has at an upper portion been provided with an outlet opening 36. The plug 46 comprises at a lower portion a surface 38, which, from a lower edge portion 40 to an upper edge portion 42, has an increasing inclination along a curved path in relation to an upwardly directed cooling medium flow in the tubular element 32. With such a shape, the surface 38 deflects the upwardly flowing cooling medium in the tubular part element 32′ in a direction towards an upper portion of full-length fuel rod 14 with a relatively small velocity loss.

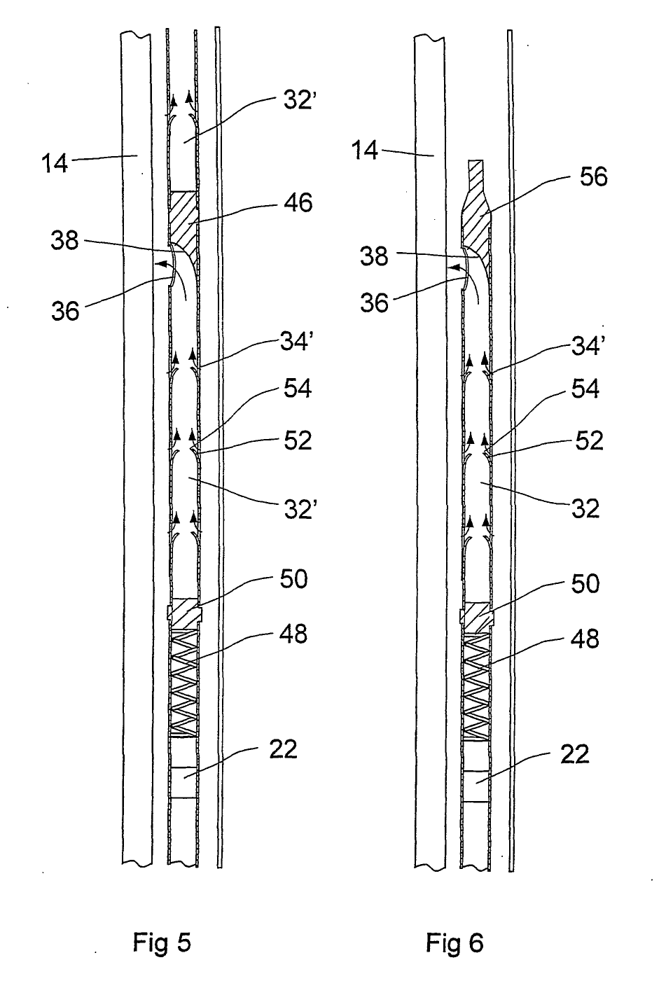

FIG. 5 shows a tubular element 32, which comprises two tubular part elements 32′. The tubular part elements 32′ have been connected coaxially to each other by a plug 46 described in FIG. 4. The part-length fuel rod 15 comprises a plurality of pellets 22, which are kept in place in the fuel rod 15 by a spring 48 and a plug 50 arranged in the upper part. A protruding upper portion of the plug 50 has here been displaced into a lower portion of the lowest tubular part element 32′ such that a coaxial connection is accomplished. The tubular part elements 32′ comprise here a plurality of inlet openings 34′ arranged at different height levels along the extension of the tubular part element 32′. The inlet openings 34′ are here arranged around substantially the whole circumference of the tubular part element 32′. The inlet openings 34′ are formed in that a second material portion 52 has been partly cut-out from the wall of the tubular part element 32′ and been bent inwardly. The inwardly bent second material portions 52 comprise an upwardly ending edge 54. By such inwardly bent second material portions 52, the existing liquid film on an external surface of the tubular part element 32 is guided, during the flowing upwardly, along the surfaces of the second material portions 52 and into the tubular part element 34. When the liquid film reaches the ending edges 54 of the second material portions 52, the liquid is carried by the cooling medium flow upwardly in the tubular part element 32′. The cooling medium in the tubular part element 32′ obtains thereby a relatively high content of liquid, which is desirably in order to be able to cool an adjacent full-length fuel rod 14.

FIG. 6 shows a tubular element 32, which is relatively short. It has an ending upper end located at a level below the second level 26. A plug 56 has here been arranged at the upper end. The plug 56 comprises at a lower located portion, in a corresponding way as the plug 46 in FIG. 5, a surface 38 which is arranged to deflect the upwardly flowing cooling medium in the tubular element 32 out through the outlet opening 36. The construction of the tubular element 32 corresponds otherwise to the embodiment of the tubular part element 32′ in FIG. 5.

The present invention is not in any way restricted to the embodiments showed in the drawings but may be modified freely within the scope of the claims. For example, the tubular elements 32, 32′ according to the invention may disclose both inlet openings 34 of the kind shown in FIG. 2 and inlet openings 34′ shown in FIG. 5. One and the same tubular element 32, 32′ may also comprise inlet openings 34 and outlet openings 36 in different directions.

1. A fuel assembly (10) for a nuclear boiling water reactor, wherein the fuel assembly (10) comprises a plurality of full-length fuel rods (14), which extends from substantially a first level (24) located in a lower part of the fuel assembly (10) to substantially a second level (26) located in an upper part of the fuel assembly (10), at least one part-length fuel rod (15), which extends substantially from said first level (24) and upwardly but not right up to the second level (26) and at least one tubular element (32), which is arranged in an area located above the position of the part-length fuel rod (15) in the fuel assembly (10), wherein a cooling medium is arranged, during operation of the boiling water reactor, to flow upwardly through the fuel assembly (10) in order to cool the fuel rods (14, 15) and that at least a part of the cooling medium flow, which passes through said area, is arranged to be guided into the tubular element (32, 32′) through at least one inlet opening (34, 34′) and out through at least one outlet opening (36), characterised in that the tubular element (32, 32′) comprises, in the vicinity of the outlet opening, an internally arranged body (44, 46) having a surface (38), which is arranged to deflect at least a main part of the upwardly directed cooling medium flow in the tubular element (32, 32′) out through the outlet opening (36) and in a direction towards a full-length fuel rod (14).

2. A fuel assembly according to claim 1, characterised in that said surface (38) comprises an inclined path having an extension from a lower edge portion (40) to an upper edge portion (42) in a direction towards the outlet opening (36).

3. A fuel assembly according to claim 2, characterised in that said inclined path comprises, in a direction towards the outlet opening (36), an increased inclination in relation to the upwardly directed cooling medium flow in the tubular element (32).

4. A fuel assembly according to the claims 2 or 3, characterised in that the upper edge portion (42) is connected to a wall portion (45) of the tubular element (32, 32′), which wall portion (45) defines an upper edge of the outlet opening (36).

5. A fuel assembly according to any one of the claims 2 to 4, characterised in that the lower edge portion (40) is connected to a wall portion, which is located at an opposite side of the outlet opening (36) in the tubular element (32).

6. A fuel assembly according to claim 5, characterised in that said body comprises a partly cut-out first material portion (44), which has been bent inwardly in the tubular element (32, 32′) such that the originally inner surface of the cut-out first material portion (44) forms said surface (38) and that the cut-out surface in the wall of the tubular elements (32, 32′) forms an inlet opening (34).

7. A fuel assembly according to claim 6, characterized in that the original upper edge portion (42) of the first material portions (44) is, by a fastening means, connected to said wall portion (45), which defines an upper edge of the outlet opening (36).

8. A fuel assembly according to any one of the preceding claims, characterised in that said surface (38) extends across the whole inner cross section area of the tubular element (32, 32′).

9. A fuel assembly according to claim 8, characterised in that said body comprises a plug (46, 50, 56), which comprises said surface (38) at a lower portion.

10. A fuel assembly according to claim 9, characterised in that said plug (46, 50) also is arranged to allow a joining of the tubular element (32, 32′) with the part-length fuel rod (15) and/or other tubular elements.

11. A fuel assembly according to any one of the preceding claims, characterised in that said inlet openings (34′) comprises a plurality of partly cut-out and inwardly bent second material portions (52) in the wall surface of the tubular element (32, 32′).

12. A fuel assembly according to any one of the preceding claims, characterised in that the tubular element (32, 32′) is arranged in a position close to the casing wall (12) of the fuel assembly (10).

13. A fuel assembly according to any one of the preceding claims 1-11, characterised in that the tubular element (32, 32′) is arranged in a position close to a central cooling medium channel (28) of the fuel assembly (10).

14. A tubular element arranged to be provided in a fuel assembly (10) for a nuclear boiling water reactor, wherein the fuel assembly (10) comprises a plurality of full-length fuel rods (14), which extend from substantially a first level (24) located in a lower part of the fuel assembly (10) to substantially a second level (26) located in an upper part of the fuel assembly (10) and at least one part-length fuel rod (15), which extends substantially from said first level (24) and upwardly but not right up to the second level (26), wherein said tubular element (32) is arranged to be provided in an area located above the position of the part-length fuel rod (15) in the fuel assembly (10), wherein a cooling medium is arranged, during the operation of the boiling water reactor, to flow upwardly through the fuel assembly (10) in order to cool the fuel rods (14, 15) and that at least a part of the cooling medium flow, which passes through said area is arranged to be guided into the tubular element (32, 32′) through at least one inlet opening (34, 34′) and out through at least one outlet opening (36), characterised in that the tubular element (32, 32′) comprises, in the vicinity of the outlet opening (36), an internally arranged body (44, 46), which has a surface (38) arranged to deflect at least a main part of the upwardly directed cooling medium flow in the tubular element (32, 32′) out through the outlet opening (36) and in a direction towards a full-length fuel rod (14).

15. A tubular element according to claim 14, characterised in that said surface (38) comprises an inclined path, which has an extension from a lower edge portion (40) to an upper edge portion (42) in a direction towards the outlet opening (36).

16. A tubular element according to claim 15, characterised in that said inclined path comprises, in a direction towards the outlet opening (36), an increasing inclination in relation to the upwardly directed cooling medium flow in the tubular element (32).

17. A tubular element according to claim 15 or 16, characterised in that the upper edge portion (42) is connected to a wall portion (45) of the tubular element (32, 32′), which wall portion (45) defines an upper edge of the outlet opening (36).

18. A tubular element according to any one of the claims 15 till 17, characterised in that the lower edge portion (40) is connected to a wall portion located at an opposite side of the outlet opening (36) in the tubular element (32).

19. A tubular element according to claim 18, characterised in that said body comprises a first partly cut-out material portion (44), which has been bent inwardly in the tubular element (32, 32′) such that the original inner surface of the cut-out first material portion (44) forms said surface (38) and that the cut-out area in the wall of the tubular element (32, 32′) forms an inlet opening (34).

20. A tubular element according to claim 19, characterised in that the originally upper edge portion (42) of the first material portion (44) is, by a fastening means, connected to said wall portion (45), which defines an upper edge of the outlet opening (36).

21. A tubular element according to any one of the preceding claims 14 to 20, characterised in that said surface (38) extends across the whole inner cross section area of the tubular element (32, 32′).

22. A tubular element according to claim 21, characterised in that said body comprises a plug (46, 50, 56), which comprises said surface (38) at a lower portion.

23. A tubular element according to claim 22, characterised in that said plug (46, 50) also is arranged to allow a joining of the tubular element (32, 32′) with the part-length fuel rod (15) and/or other tubular elements.

24. A tubular element according to any one of the preceding claims 14 to 23, characterised in that said inlet openings (34′) comprise a plurality of partly cut-out and inwardly bent second material portions (52) in the wall surface of the tubular element (32, 32′).

25. A tubular element according to any one of the preceding claims 14 to 24, characterised in that the tubular element (32, 32′) is arranged in a position close to the covering wall (12) of the fuel assembly (10).

26. A tubular element according to any one of the preceding claims 14 to 24, characterised in that the tubular element (32, 32′) is arranged in a position close to a central cooling medium channel (28) of the fuel assembly (10).
